(19) United States
(12) Patent Application Publication
(10) Pub. No.: US 2014/0108156 A1
(43) Pub. Date: Apr. 17, 2014

(54) METHODS AND SYSTEMS FOR EXTRACTING AND MANAGING LATENT SOCIAL NETWORKS FOR USE IN COMMERCIAL ACTIVITIES

(71) Applicant: Talk3, Inc., Northfield, IL (US)

(72) Inventor: Eric HILLERBRAND, Wilmette, IL (US)

(73) Assignee: Talk3, Inc., Northfield, IL (US)

(21) Appl. No.: 14/133,053

(22) Filed: Dec. 18, 2013

Related U.S. Application Data
(63) Continuation-in-part of application No. 12/753,577, filed on Apr. 2, 2010, now abandoned.
(60) Provisional application No. 61/166,205, filed on Apr. 2, 2009.

(51) Int. Cl. G06Q 50/00; G06Q 30/02

(52) U.S. Cl. CPC G06Q 50/01; G06Q 30/0269
USPC 705/14.66

(57) ABSTRACT

A system and method for extracting and managing latent social networks is described. The system generally comprises a network modeling component, a digital information component coupled to the network modeling component, and at least one third party computer system coupled to the network modeling component over a first network. The method operates to process user data to identify and extract at least one latent social network, and identify user needs within the network. The method also allows communications between a first entity (such as a brand or advertiser) and the user, such that information relating to the identified user needs may be delivered directly to the user.

### CROSS REFERENCE TO RELATED APPLICATIONS

This application is continuation application of U.S. Non-provisional patent application Ser. No. 12/753,577, filed Apr. 2, 2010, which claims priority to U.S. Provisional Patent Application No. 61/166,205, filed Apr. 2, 2009. The entirety of all the above-listed applications are incorporated herein by reference.

This application is related to U.S. patent application Ser. No. 12/726,460, filed Mar. 18, 2010, the entire contents of which are incorporated by reference, as if fully set forth herein.

### FIELD OF THE INVENTION

The present invention relates generally to modeling the form and function of latent social networks related to a specific human activity and, more particularly, to computer-implemented methods and systems for enabling the extraction, management and merging of models of these latent social networks and using these networks to drive commercial activities. More specifically, the present invention identifies methods and systems for processing user data to identify a latent social network, processing user data to identify user need states, enabling communication and collaboration with members of latent social networks through such activities as micro-blogging, instant messaging, polling or surveys, delivering recommended information including promotions and social relationships relevant to the user need, and providing the ability to purchase products tied to promotions regardless of whether the user is online or in a physical store.

### BACKGROUND OF THE INVENTION

In the increasingly heterogeneous Internet environment pressure is being placed on managing the interplay of networks of people (e.g., the Facebook® community), networks of processes or functions (e.g., a network that performs a function which could include a computer system with distributed data or computational services or a social network engaged in a specific activity or function such as Mint®) and networks of content (e.g., a published of online ecommerce content such as online coupons, fliers, or advertising) both within established or free-forming networks of interactions, or across and between such networks. A network may be defined as a set of people who share a specific characteristic or purpose. A latent network comprises of a set of people who share a specific characteristic or purpose but who have not been explicitly connected through a deliberate action to join or connect with others like them. The process of management is fundamentally distinct from traditional system interoperability or integration activities. In the traditional process, the intent is to connect two systems together through either a proprietary or open application interface (API), capturing system level events, and then using predetermined events to create inter-system messages that are captured, transformed and routed based on some process logic.

In the Internet environment, the traditional systems level integration (which might be considered a single dimensional activity) is no longer adequate. Instead, the interplay between persons, commerce, process, and content within specific contexts creates the requirement for a much more robust n dimensional model for these multiple dimensions. The movement towards open systems, cloud based computing with multiple datastores or feeds, and social aggregators and integrators are forcing the n-dimensional model of latent social connections.

In the Internet environment, users often maintain multiple identities across multiple platforms. For example, a user might have a cell phone, several text message user accounts, and several identities on social networking sites (e.g., Facebook®, Twitter®, MySpace®, etc.), and participate with multiple different user names. As users connect to users, and thereby, multiple identities connect to multiple identities, the problem of understanding these identifies, tracking them, and integrating these identities becomes overwhelming. As a social network expands, and users are faced with managing multiple levels of connections (i.e., typically ‘friends of friends’) the problem grows in complexity. The critical task becomes managing these identities and defining the correct network of individuals that are tied to a specific life task.

Further, the dynamism of network evolution, whether social, system, or procedural networks, rejects static, uni-dimensional, context-free integration activities. Human interaction is innately messy. Despite occasional trappings of formality, the underlying behavior frequently borders on the chaotic. As a result, established business and social processes both tend to morph and evolve over time. Dialogs are often incomplete. True intent is often veiled and the real nature of the underlying relationship is elusive. This does not imply that human behavior is necessarily evil, but rather, it overstates the obvious. Human networking is not a deterministic phenomenon.

Human activity does not conform to neat data models, knowledge representations, or ontological structures. It defies categorization and classification typically associated with data mining. It exceeds the limitations of natural language processing. Rather human behavioral interaction patterns represent the type of complexity discovered throughout the natural world. Just as bees and ants cooperate to form functional colonies, humans cluster into far more complex but equally productive social structures. Just as the human spawned Internet creates small world phenomena, human relationships also exhibit the same attributes. Even the architecture of the human body mimics the complex evolutionary architectures repeat throughout nature. In short, human behavior and the very human structure are both governed by the natural laws stemming from the study of complex behaviors.

Complexity, a relatively new and highly profound concept, challenges existing notions of our universe. Complexity works in harmony with the accepted principles of the hard sciences such as physics, chemistry and biology. It also extends deeply into the social sciences. The study of complexity continues to both reinforce and unify these heretofore separate disciplines. It is a far reaching concept which permits observation of non-deterministic behavior with predictable results. This is significant when it comes to understanding and interpreting human interaction.

Complexity plays out in the marketplace. It is present in international politics and underlies the emergent “global village”. It is definitely at play in the international war on terror. It simply cannot be overlooked. At the same time, complexity is contrary to the way we have been accustomed to managing computation. Based upon binary realities, computer science has grown up in a deterministic world where precision reigned supreme. In indirect recognition of complexity, however, the ascent of the Internet, biological computing and more recently Web 2.0 social networks begin to move computational behavior away from precision computing. These phenomena open the door to more natural networks. In essence, computation is adapting to reflect and reinforce the world wide society that produced it.

Thus, to effectively measure or classify human behavior, manage the interactions of process, information sharing, and commerce, assess relationships and ascribe motivation, complex behavioral patterns must come into play. Ironically, up to this point, these models have largely been seen as subsumable in the application of semantics, a natural offshoot of human networking behavior. Ontological modeling, semantic definition, and Web 3.0 or Semantic Web applications cannot quantify this level of complexity.

Semantics, however, are inherently impossible to define through rule based approaches such as natural language processing or grammar based parsers. There is far too much nuance, contextual definition, and idiom for a system using these traditional approaches to scale. Eventually an army of knowledge engineers, ontologists, and minders of taxonomies and controlled vocabularies, must be mustered to support those rules. Even then, recent experience shows a phalanx of knowledge workers just cannot keep track of all the specialized rules for unique circumstances and innumerable exceptions. This problem redoubles in the burgeoning world of service oriented architectures as new services and their rule sets proliferate unabated. Semantics are really applied complexity. Despite ongoing herculean efforts to do so, they too cannot be managed deterministically.

The traditional process of building architectures and their associated ontologies and taxonomies requires labor intensive analysis at the detail level. Typically, this costly manual process yields static products, often outdated at the moment of their creation. While such products serve to meet existing reporting and compliance requirements, they contribute very little to real operational or system design issues.

The traditional process also frequently operates under the implicit assumption that there must be a single correct answer. This assumption discounts the myriad of real-world variables which contribute to practical contextual variation. In reality, the correct answer is dependent on the specific context and the relevant use cases can be extensive and dynamic in their own right.

The path to better Internet software is thought to be merely a case of generating new algorithms or tweaking old ones, whether behavioral targeting, neural networks, collaborative filtering, data mining or thousands of other names for algorithms to achieve data fusion. Those approaches are all wrong for today's Internet because these algorithms and statistical approaches assume determinism—a specific correct solution, that applies across the board and in all cases.

Rather, networking modeling must be viewed not as a semantic definition problem but as a living example of emergent complexity. The world is complex and beyond the capability of human definition. The approach adopted in the present invention embraces the chaos, garbage and noise associated with any organized or relatively disorganized network behavior. By accepting all the artifacts of network interaction, human or system, the resulting pattern better reflects the actual interactions and reveal the underlying natural patterns in otherwise imperceptible ways.

As discussed above, conventional network modeling techniques do not allow for the identification of latent social networks. Because latent social networks provide a means of identifying user needs and directing specific advertising and other communications to the users within the social network (to influence purchasing decisions), the identification of latent social networks is a key concept in the development of the Internet as a means of communication.

Accordingly, there is presently a need for a system and method for extracting and managing latent social networks for use in commercial activities, such as advertising and promotion of products for purchase, both online and in physical stores.

### SUMMARY OF THE INVENTION

An exemplary embodiment of the present invention comprises a computer system including at least one server computer and at least one client computer coupled to the at least one server computer through a network, wherein the at least one server computer includes at least one program stored thereon, said at least one program being capable of performing the steps of extracting data from one or more social networks, extracting data from content socially generated by one or more users, processing the user socially generated content to identify at least one latent social network based on a specific context, and processing a first set of user data to identify at least one user need of a user within the at least one latent social network.

An exemplary embodiment of the present invention also comprises a computer system including a network modeling component, a digital information component coupled to the network modeling component, and at least one third party computer system coupled to the network modeling component over a first network.

An exemplary embodiment of the present invention also comprises a computer readable medium having embodied therein a computer program for processing by a machine, the computer program including a first code segment for extracting data from one or more social networks, a second code segment for extracting data from content socially generated by one or more users, a third code segment for processing the user socially generated content to identify at least one latent social network based on a specific context, and a fourth code segment for processing a first set of user data to identify at least one user need of a user within the at least one latent social network.

### BRIEF DESCRIPTION OF THE DRAWINGS

The invention will be better understood with reference to the following detailed description, of which the following drawings form an integral part.

FIG. 1 is a schematic diagram of a computer system according to an exemplary embodiment of the present invention.

FIG. 2 is a flow diagram showing the processing of digital information by the information processing component shown in FIG. 1.

FIG. 3 is a flow diagram showing the processing of digital information by the application processing component shown in FIG. 1.

FIG. 4 is a block diagram showing an exemplary communication system for permitting brands to correspond with members of a latent social network.

FIG. 5 is a block diagram showing a logical data model for organizing user information.

FIG. 6 is a block diagram showing a logical data model product and promotional information.

FIG. 7 is a block diagram showing a system for storing user data according to a first exemplary embodiment of the present invention.

FIG. 8 is a block diagram showing a system for storing user data according to a second exemplary embodiment of the present invention.

FIG. 9 is a block diagram showing a system for storing user data according to a third exemplary embodiment of the present invention.

### DETAILED DESCRIPTION

### Background

The present invention puts users in direct conversations with brands, and relevant networks of friends and other consumers, from the point of inspiration to the point of transaction based on identifying relevant latent social networks. Latent social networks can be used share commercial information, social influence and brand advocacy by consumers, or create communities that aid in product ideation, development and support. These latent social networks may be created by brands, sponsored by brands, or generated with brand participation. Users can receive customized promotions delivered at the point of sale using a network based affiliate model.

The present invention helps consumers enter into meaningful conversations with brands and specific commerce communities by identifying latent connections between the user, their product preference, and ‘social influencers’ (i.e., people who can enhance the likelihood of purchase through recommendation and guidance). Whether at the point of inspiration or transaction, a user can create and share preferences, share those preferences with others, and use a number of information sharing devices such as a polling feature that allows users to answer a poll, create a poll, or review answers. Polls can be submitted in real time to an identified latent network of users, friends, experts and the brands themselves. Polls are a single device for facilitating knowledge. Real-time micro-blogging or instant messaging, or less that real-time collaborative knowledge creation tools (e.g., Wikipedia®) can also be used. Any information sharing device accomplishes two things: First, it increases the profiles of individuals and refines the latent social network in which they are a part; and second, it helps the value of latent social network participation through information creation and sharing. The penultimate value is that users receive customized promotions augmented by the participation and social influence of the social network. It should understood that promotions are used as an example of the type of communication that occurs between brand and consumer. Those of ordinary skill in the art will appreciate that a wide range of marketing communications, such as information, loyalty rewards, brand awareness, and market research, can be delivered using an individual's identification with a latent social network. Customized promotions offer brands the ability to exert a high degree of control including targeting promotions at specific SKU-levels even at the point of sale. Users provide access to their on-line data which enriches their profile and enhances the conversations that they carry on with brands.

As preferences information is collected consumers can being to engage brands and brands actively purchase preference data and engage in the highest level of targeted marketing messages managing and monetizing preference information and tracking those preferences to point of transaction. Using mobile phone location sensitivity (e.g., through Global Position Sensor (GPS) tracking), users can immediately connect to others at the same location around the same topic or interest tied to their membership and identification with one or more latent social networks.

Using location based services users can connect with latent networks of others who can help with the transactions. Users can redeem customized promotions at a SKU specific level that reflect individual preference instantly whether online or in-store regardless of brand/retailer participation. For example, a user walks into a specific retailer store and is immediately engaged in a conversation. Each social influencer is compensated for their participation as part of latent social network based affiliate model.

In the present invention latent social networks are identified based on the semantic processing of relationships between people, the content produced on-line by people, the content consumed by people, and their online behavioral patterns. As information is processed and behavior tracked, latent networks emerge. Latent networks are identified using a number of algorithms. Rather than build a system on a specific algorithm or group of algorithms, the inventions presumes an infinite number of algorithms that are possible. Each algorithm or combinations of algorithms represents computationally a connected path of processing. Some algorithms or combinations are more powerful.

In the present invention, information generated by users allows for the development of sophisticated networks, tying the networks together into ‘networks of networks,’ and creating opportunities for sophisticated models of meta-network interactions and highly targeted communications and recommendations. Multiple networks include the merging of multiple latent social networks dictated by a changing context (i.e., location or intent), merging of multiple brand or marketing networks, or the merging of brand and consumer networks together. The invention exercises a number of sophisticated algorithms to build and manage the connections between individuals, the content they produced and their relationships.

Algorithms are also used to identify targeted marketing promotions which can be delivered based on the user's stated preference. In the present invention, a number of promotional delivery methods and systems are identified.

### DESCRIPTION OF SPECIFIC EXEMPLARY EMBODIMENTS

The present invention relates generally to modeling the form and function of latent social networks related to a specific human activity and, more particularly, to methods and systems for enabling the extraction, management and merging of models of these latent social networks and using these networks to drive commercial activities. More specifically, the present invention identifies methods and systems for processing user data to identify networks, utilize polling or survey, or other information creation and exchange techniques, to further clarify user need, deliver information, promotions, and social relationships relevant to the user need, use these social relationships to further articulate need and target users, use these social relationships to facilitate the creation and use of promotions, and provide the ability to purchase products tied to promotions regardless of whether the user is online or in a physical store. These models are exposed to computer systems through an application interface (API) or as a readable data model either in Bache mode or real time.

Computer-interpretability allows software applications to be created that perform: (i) automatic integration of disparate datastores, online web applications, and computer systems containing information about users, their social relationships and online behavior; (ii) automatic interpretability of user behavior; (iii) automatic computer process for identifying one or more user characteristic; (iv) automatic computer process for identifying one or more individual who shares an explicit or implicit characteristic; (v) automatic computer process for allowing a user to interact with those individuals who share an explicit or implicit characteristic; (vi) automatic data integration to allow software automatically to translate and transform between disparate data based on a specific objective; (vi) automatic matching of promotions, advertisements or other content based on user need to allow software automatically to translate and transform between disparate data based on a specific objective; and (vii) automatic computer process for allowing a user to execute a promotion at point of sales whether on line or in a physical store using a virtual check out that doesn't require merchant participation. Briefly described, aspects of the present invention include a method for creating models of latent social networks. Latent social networks are networks in which users are matched by one or more characteristics and the users have not explicitly connected or identified themselves as connected in a network. Examples of a latent social network include users who share a particular point of view, skill, background, knowledge or interest, or any combination of these factors. For example, ‘mothers of young children who are worried about finding nutritious items to pack on school lunches’.

### First Exemplary Embodiment

A first exemplary embodiment of the present invention comprises a method including the steps of: (a) processing descriptive information that is in a digital format and describes each user's behavior, the content they have produced and the content that they have consumed, and the relationships that they have with other users including shared trust and reputation; (b) establishing relationships between the processed information and any other information in a computer system datastore including processing of information related to the user through APIs or techniques; (c) establishing the degree the processed information and the relationships conform to some predetermined pattern; (d) establishing connection weights and other attributes based on the relationships and pattern match for each computational algorithm; (e) using computational algorithms for determining which executed algorithms' patterns best fit against some criteria; (f) providing feedback on the correctness or incorrectness of identified patterns and using learning algorithms for optimizing weights, relationships, and patterns; (g) executing computational algorithms against the processed information and their connections for the purposes of identifying relationships and patterns across and between network models; (h) executing computational algorithms for establishing the best fit of relationships and patterns for models of networks of networks against some criteria; (i) providing feedback on the correctness or incorrectness of identified patterns and using learning algorithms for optimizing the weights, relationships, and patterns for a model of networks of networks; and (g) whereby the resultant information and relationships conforming to the optimized pattern create a latent social network.

The first exemplary embodiment of the present invention, it will be appreciated, involves a set of networks containing resources, and the cross and between network interactions and systems of interactions. In the first exemplary embodiment a network may comprise people, their behavior, content that they have produced or consumed, and existing latent or explicit networks in which they are members. In an another exemplary embodiment of the present invention latent social networks may comprise computer processable models that define explicit and latent entities, sets of those entities, their relationships, rules, and information and operational flows regarding the entities and their relationships using description logic. In the present invention a latent social network comprises a common operating picture of the operation of a set of connections between latent social networks and resources. Descriptive information may comprise digital information that is stored on a computer system. The processing of descriptive information may comprise tokenizing information by parsing the information based on one or more algorithms. Establishing connections between processed information establishes the proximity relationships between processed information and any person. Feedback may comprise the use of training and learning algorithms.

### Second Exemplary Embodiment

A second exemplary embodiment of the present invention comprises a method of computing to address a predetermined computing requirement for extracting, creating, and merging models of social networks. This method comprises steps of: (a) processing digital information to identify shared characteristics of people; (b) establishing the connections between the processed information and any other information in the system datastore based on one or more algorithms; (c) executing computational algorithms against the processed information and their connections for the purposes of identifying relationships and patterns; (d) executing computational algorithms for establishing the best fit of relationships and patterns against some criteria; (e) providing feedback on the correctness or incorrectness of identified patterns and using learning algorithms to reestablish the weights, relationships, and patterns; (f) executing computational algorithms against the processed information and their connections for the purposes of identifying relationships and patterns across and between social network models; (g) providing feedback on the correctness or incorrectness of identified patterns and using learning algorithms reestablish the weights, relationships, and patterns of a model of latent social networks; (h) executing computational algorithms against the processed information and their connections for the purposes of identifying relationships between networks and one or more promotions, advertisements, or opportunities; (i) customizing the promotion to the individual characteristics; (j) executing computer algorithms that determine the level of trust and reputation for members of a latent network; and (k) whereby extracted information based on patterns creates a model of latent social networks.

### Third Exemplary Embodiment

A third exemplary embodiment of the present invention comprises a method of computing to automatically integrate disparate datastores and computer systems containing information about users, their social relationships and online behavior. This method comprises steps of: (a) extracting relevant information from datastores provided by users, (b) extracting relevant information from the World Wide Web (WWW) provided by users.

### Fourth Exemplary Embodiment

A fourth exemplary embodiment of the present invention comprises a method of computing to address a predetermined computing requirement for extracting, creating, and merging individual characteristics using techniques for sharing information such as polling or survey questions. This method comprises steps of: (a) processing information about individuals, their relationships, content they produced and consumed and (b) establishing latent characteristics that define sets of networks of individuals.

### Fifth Exemplary Embodiment

A fifth exemplary embodiment of the present invention comprises a method of computing to address a predetermined computing requirement for extracting, creating, and merging individual characteristics using techniques for communicating such as instant messaging, or in microblogging or text messaging using an internal or third party messaging service. This method comprises steps of: (a) processing information about individuals, their relationships, content they produced and consumed (b) establishing latent characteristics that define sets of networks of individuals, and (c) directing communication or content to specific members of a latent social network based on a latent association based on a change of context thereby creating a smaller latent social network within a larger network.

### Sixth Exemplary Embodiment

A sixth exemplary embodiment of the present invention comprises a method of computing to address a predetermined computing requirement for extracting, creating, and merging individual preferences and requirements. This method comprises the step of: (a) providing interactive tools in which the user behaviorally indicates interest level and preference.

The present invention in this exemplary aspect, it will be appreciated, comprises a network of social networks comprising a set of individuals, content, behaviors, and relationships and interactions with other users. In this aspect, the present invention comprises models defining one or more latent social network and the interrelationships between them. A latent social network may describe explicit and latent entities, sets of those entities, their relationships, rules, and information and operational flows regarding the entities and their relationships using description logic and that this description logic is extracted from the processing of information associated with the user. A network may comprise knowledge of individuals and may be selected from a group comprising but not limited to people, content, policies, procedures, computer systems and information, and the interrelationships. In another exemplary embodiment of the present invention, descriptive information may comprise digital information that is stored on a computer system or that is available through an interface. The processing of information comprises tokenizing information by parsing the information based on one or more algorithms. The algorithms define connections that establish proximity relationships between processed information and any other information in the system. Feedback may comprise training and learning algorithms.

In the sixth exemplary embodiment, processes may be implemented that let users collaboratively interact with users at the point of commercial transaction. Processes of disambiguating information may comprise one or more processes for creating a common canonical format or root. A file system may comprise files organized based on fractal mathematic formula.

In the sixth exemplary embodiment, there may be computation of topological features including number, type, strength, and weighting of connections between tokens. Computational algorithms may be selected from a group comprising but not limited to: classifiers, linear and non-linear statistical modeling techniques, latent semantic analytic techniques, genetic algorithms and evolutionary computation. Representational logics may comprise languages and representational notation that describe the semantic definition of entities and their relationships. Representational logic may be selected from the group comprising but not limited to: Extensible Markup Language (XML), DARPA Agent Markup Language (DAML), Web Ontology Language (OWL), Resource Description Framework (RDF), folksomony, collaborative tagging, social mark-up or other logical notation.

### Seventh Exemplary Embodiment

A seventh exemplary embodiment of the present invention comprises a method of computing to address a predetermined computing requirement for extracting, creating, and merging individual characteristics using polling or survey questions. This method comprises steps of (a) processing digital information created by users in the form of survey or poll questions; (b) executing computational algorithms against the processed information and their connections for the purposes of identifying relationships and patterns; (c) executing computational algorithms for establishing the best fit of relationships and patterns against some criteria; (d) providing feedback on the correctness or incorrectness of identified patterns and using learning algorithms to reestablish the weights, relationships, and patterns; (e) executing computational algorithms for matching questions to users based on some user characteristic or latent social network membership; (f) executing computational algorithms for searching for specific questions or responses based on semantic meaning or metadata; and (g) whereby extracted information can be presented to a user.

### Eighth Exemplary Embodiment

An eighth exemplary embodiment of the present invention comprises a method of computing a model of the relationships between two or more persons in one or more social networks. This disclosed method comprises the steps of: (a) processing digital information describing the persons and social networks; (b) establishing the connections between the processed information and any other information in the system datastore based on one or more algorithms; (c) describing those connections across n number of dimensions; (d) establishing the weights of the connections between processed information and any other information in the system datastore; (e) executing computational algorithms against the tokens and their connections for the purposes of identifying relationships and patterns; (f) executing computational algorithms for establishing the best fit of relationships and patterns against some criteria; (g) providing feedback on the correctness or incorrectness of identified patterns and using learning algorithms reestablish the weights, relationships, and patterns; and (h) whereby the resultant model defines the interactions between two or more persons in terms of shared content, process, and commerce.

In the eighth exemplary embodiment, definitions may be selected from the group comprising: content produced by two or more persons, user profile data produced by two or more persons; user behavior produced by two or more persons. In the exemplary embodiment, the relationship between two or more persons may comprise a relationship weight. In another exemplary embodiment the relationship between two or more persons across two or more social networks may comprise a relationship weight. The weighting of the relationship may comprise an affinity measurement. In the exemplary embodiment an affinity measurement may comprises a statistical measure of the degree of similarity between two persons.

### Ninth Exemplary Embodiment

A ninth exemplary embodiment of the present invention comprises a method of computing a model of the relationship between one or more persons in one or more social networks and promotions, advertisements, and product offerings. The disclosed method comprises steps of: (a) processing digital information describing the persons, products and social networks; (b) establishing the connections between the processed information and any other information in the system datastore based on one or more algorithms; (c) describing those connections across n number of dimensions; (d) establishing the weights of the connections between processed information and any other information in the system datastore; (e) executing computational algorithms against the tokens and their connections for the purposes of identifying relationships and patterns; (f) executing computational algorithms for establishing the best fit of relationships and patterns against some criteria; (g) providing feedback on the correctness or incorrectness of identified patterns and using learning algorithms reestablish the weights, relationships, and patterns; and (h) whereby the resultant model defines the affinities between one or more persons in terms of product preferences, interests, and likelihood of purchase.

In the ninth exemplary embodiment the processed information may be selected from the group comprising but not limited to: content produced by two or more persons, user profile data produced by two or more persons; user behavior produced by two or more persons and product descriptions. Relationships may be identified through patterns organized as one or models that describe the commerce process. A relationship between two or more persons may be defined through a relationship weight. A relationship between two or more persons and product interest may comprise relationship weight. A relationship between two or more persons across two or more social networks and product interest may comprise a relationship weight. The weighting of the relationship may comprise an affinity measurement. The affinity measurement may be a statistical measure of the degree of similarity between a person and a product. An affinity measurement may also comprise a statistical measure of the degree of similarity between two persons and a product.

### Tenth Exemplary Embodiment

A tenth exemplary embodiment of the present invention comprises a method of computing a model of the presentation of product information to a person based on a person's social relationships within a social network. The disclosed method comprises steps of: (a) processing digital information describing the persons, products and social networks; (b) establishing the connections between the processed information and any other information in the system datastore based on one or more algorithms; (c) describing those connections across n number of dimensions; (d) establishing the weights of the connections between processed information and any other information in the system datastore; (e) executing computational algorithms against the tokens and their connections for the purposes of identifying relationships and patterns; (f) executing computational algorithms for establishing the best fit of relationships and patterns against some criteria; (g) providing feedback on the correctness or incorrectness of identified patterns and using learning algorithms reestablish the weights, relationships, and patterns; and (h) whereby the resultant model defines the message content, offer, cost, promotion, schedule, and delivery mechanism between one or more persons and a product.

In the tenth exemplary embodiment a personalized message based on social relationships may be selected from a group comprising but not limited to: content reflecting endorsement, interest, use, recommendation, and advice. Patterns may be selected from a group comprising but not limited to: neuro-cognitive models that define social influence, attitude change, social commerce, and consumer decision-making. Neuro-cognitive models defining social commerce patterns.

### Eleventh Exemplary Embodiment

An eleventh exemplary embodiment of the present invention comprises a method for creating an ontology or representation of a latent social network comprising steps of: (a) parsing digital information; (b) executing one or more computer processes that analyze the digital information for identifying various patterns; (c) executing one or more computer processes that analyze the patterns based on a specific context; (d) producing the output; (e) flagging the output as correct or incorrect, adjusting the weights of pattern relationships; (f) re-executing one or more computer processes that analyze patterns passed on specific context; (g) repeating the execution of processes, producing of output, and flagging the output until a correct model is produced; and (h) whereby the resultant model is transformed into an ontology. As will be appreciated an embodiment of the method ontologies may be of description logics including XML, OWL, and RDF.

### Twelfth Exemplary Embodiment

A twelfth exemplary embodiment of the present invention comprises a method for allowing users within a latent social network to share and redeem a promotion with their mobile device or browser with any merchant regardless of merchant participation. In the twelfth exemplary embodiment of the present invention a method for sharing and redeeming a promotion at any merchant regardless of merchant participation is disclosed and comprises the steps of: (a) identifying a latent social network; (b) identifying within a latent social network users who are influential based on profile attributes, trust or expertise, (c) creating an incentive that incents the user who is influential to share the promotion, (d) tracking the sharing of the promotion in which the value of the promotion changes based on the extent that is shared, (e) allowing users to register one or more credit or debit cards, (f) presenting a promotion in a mobile or browser and allowing a merchant to scan or enter the promotion code, (g) crediting the user's credit card in real time with the value of the promotion by matching the registered credit card with financial data obtained from a financial processing network including product sku, purchase price and promotion redemption.

In this exemplary embodiment, a user is able to select a product/service, agree upon a price, check inventory, pay the price, receive a discount based on a promotion, arrange shipping, and complete the transaction.

### Thirteenth Exemplary Embodiment

A thirteenth exemplary embodiment of the present invention comprises a computer system operative to address a predetermined computing requirement involving the creation, delivery and receipt of survey questions and answers across a latent social network. The system comprises components including a survey creation component, an answer process component, search component, and a recommendation/delivery component. The survey creation component processes user generated questions and parses the questions, creates tokens of the parsed information and disambiguates the information. The answer creation component processes user generated answers and parses the answers, creates tokens of the parsed information and disambiguates the information. The search component discovers and executes one or more search algorithms to match answers and questions. The recommendation/delivery component connections between tokens and stores that information in the system datastore and delivers questions and answers to users based user characteristics.

### Fourteenth Exemplary Embodiment

A fourteenth exemplary embodiment of the present invention comprises a method of computing to capture and process a user's physical location and to incorporate that location into latent social network discovery and promotion delivery.

### Fifteenth Exemplary Embodiment

A fifteenth exemplary embodiment of the present invention comprises a method of computing to address a predetermined computing requirement for allowing users to commit commercial transactions using a virtual transaction processing capability. This method comprises steps of (a) processing digital information to identify the merchant, the product, the price and the shipping; (b) executing computational algorithms against the processed information in order to create a transaction; (d) reconciling any promotion with backend financial processing systems; (e) debiting all members of the latent social network participating in the point of sale purchase with credits, money, or other loyalty-based compensation.

### Sixteenth Exemplary Embodiment

A sixteenth exemplary embodiment of the present invention comprises a method of computing to address a predetermined computing requirement for allowing users to commit commercial transactions using a virtual transaction processing capability. This method comprises steps of (a) processing digital information to identify the merchant, the product, the price and the shipping; (b) executing computational algorithms against the processed information in order to create a transaction; (d) reconciling any promotion with backend financial processing systems; (e) debiting all members of the latent social network participating in the point of sale purchase with credits, money, or other loyalty-based compensation.

### Seventeenth Exemplary Embodiment

A seventeenth exemplary embodiment of the present invention comprises a system that deploys real time promotion redemption at a physical point of sale.

### Eighteenth Exemplary Embodiment

An eighteenth exemplary embodiment of the present invention comprises a system that deploys real time promotion redemption and commercial processing within a browser (e.g., Internet Explorer®).

### Nineteenth Exemplary Embodiment

A nineteenth exemplary embodiment of the present invention comprises a computer system for allowing users to complete commercial transactions without a relationship with the merchant. The system comprises a browser (e.g., Internet Explorer®) plug-in, and a mobile application or desktop application that allows a user to access a customized promotion that is delivered to the user, purchase a product, and receive the financial benefit of the promotion at the time the transaction is processed.

### Twentieth Exemplary Embodiment

A twentieth exemplary embodiment of the present invention comprises a computer sub-system to address a predetermined computing requirement involving the store system data across in n dimensions within a specific context comprising a datastore, fractal mathematical algorithms, and N-dimensional algorithms. A datastore stores and retrieves data consisting of information, relationships, patterns, context and data attributes such as weights. Fractal mathematical algorithms are based on fractal mathematical relationships or scale free network structures. N-dimensional algorithms comprises algorithms that define an object in relationship to other objects across n-dimensional mathematical dimensions using either n-dimensional calculus, graph theory, multi-dimensional geometry, vector decomposition, rasterizing or other graphical definitional algorithms.

### Twenty-First Exemplary Embodiment

A twenty-first exemplary embodiment of the present invention comprises a method of computing operative to address a predetermined computing requirement for the creation of entity and relationship weights based on frequency of use, traversal, access, and value within a specific context.

### Twenty-Second Exemplary Embodiment

A twenty-second exemplary embodiment of the present invention comprises a method of computing to address a predetermined computing requirement for indexing a token using multiple indices and extracting the meaning of the token based on the establishment of vectors from one or more indices.

### Twenty-Third Exemplary Embodiment

An twenty-third exemplary embodiment of the present invention comprises a method of computing to address a predetermined computing requirement for managing multiple index relationships.

### Twenty-Fourth Exemplary Embodiment

An twenty-fourth exemplary embodiment of the present invention comprises a method of computing comprising algorithms that compete for best fit based on some predefined criteria and user feedback.

### Twenty-Fifth Exemplary Embodiment

An twenty-fifth exemplary embodiment of the present invention comprises a method of incenting, tracking and compensating members of a latent social network who were part of the latent social network at the time of a specific user's commercial transaction. This method comprises steps of: (a) identifying the latent social network, (b) tracking participation in the latent social network through processing of content produced and shared by network participants, (c) tracking the sharing of a promotion within the latent network, (d) tracking the sharing of a promotion through a user's explicit social network, (e) tracking the commercial value of the transaction, (f) valuing the extent of the participation using one or more techniques such as level of effort, influence, expertise or trust, and (g) compensating participants in the network based on the value of the commercial transaction and weighted based on extent of participation.

Those of ordinary skill in the art will realize that any of the methods described above according to the first through twenty-fifth exemplary embodiments may be carried out by a machine, such a computer system executing program code for performing the specific steps.

### DETAILED DESCRIPTION

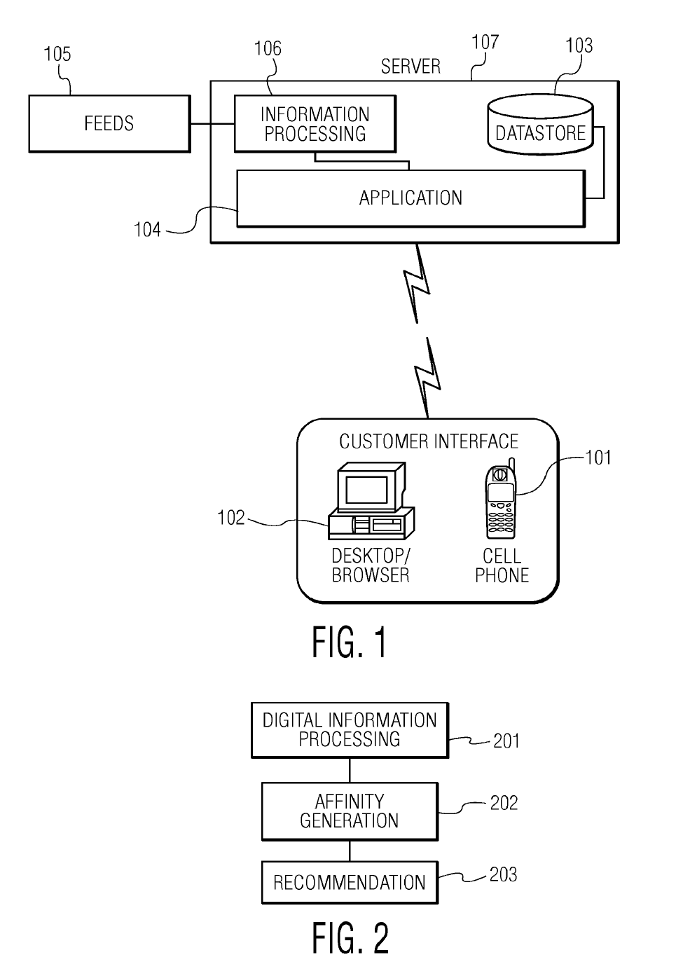

As illustrated in FIG. 1, an exemplary embodiment of the present invention comprises a computer system described in the context of a plurality of processing devices linked via a network, such as the World Wide Web or the Internet. In this regard, client devices, illustrated in the exemplary form of a desktop computer system, cell phone, etc., provide a means for a user to access an online environment and thereby gain access to content, such as media, data, webpages, catalogs, and games associated with the online environment. Since the manner by which the client devices are used to access the online environment are all well known in the art, they will not be discussed herein for the sake of brevity.

As will be further appreciated by those of skill in the art, the computing devices, as well as the computing devices within the online environment, will include computer executable instructions stored on computer-readable media such as hard drives, magnetic cassettes, flash memory cards, digital videodisks, Denoulli cartridges, nano-drives, memory sticks, and or read/write and/or read only memories. These executable instructions will typically reside in program modules which may include routines, programs, objects, components, data structures, etc., that perform particular tasks or implement particular abstract data types. Accordingly those skilled in the art will appreciate the computing devices may be embodied in any device having the ability to execute instructions such as, by way of example, a personal computer, mainframe computer, personal-digital assistant (“PDA”), cellular telephone, gaming system, personal appliance, etc. Furthermore, while various of the computing devices within the computer system illustrated in FIG. 1 are illustrated as single devices, those of skill in the art will also appreciate that the various tasks described hereinafter may be practiced in a distributed environment having multiple processing devices linked via a local or wide-area network whereby the executable instructions may be associated with and/or executed by one or more of multiple processing devices.

The exemplary computer system shown in FIG. 1 may also provide logical connections to one or more third party computing devices, such as third party content servers which may include many or all of the elements described above relative to a computing device. Communications between the client devices, the online environment, and third party computing devices may b exchanged via a further processing device, such as a network router that is responsible for network routine.

As will be explained hereinafter, the present invention relates generally to modeling the form and function of latent social networks related to a specific human activity and, more particularly, to methods and systems for enabling the extraction, management and merging of models of these latent social networks and using these networks to drive commercial activities. More specifically, the present invention identifies methods and systems for processing user data to identify networks, utilize polling or survey identify to further clarify user need, deliver information, promotions, and define latent social networks relevant to the user need, and provide the ability to purchase products tied to promotions regardless of whether the user is online or in a physical store.

However, it may be helpful to explain what is meant by some of the preceding terminology. At its simplest, the term “social network” is used to describe a set of people that share some characteristic. The interactions between these people may be defined by a set of connections. The connections may have certain attributes that differ based on a specific context. Connection attributes may include, but are not limited to, such things as to whether a connection is present or is not present in a specific context, the degree or extent of the connection, any conditional logic or rules that dictate the presence or weight of a connection. These connections are defined, within the context of the present invention, across n number of dimensions. These dimensions define sets of connection types for a specific entity. By way of example, an entity such as ‘parent’ may connect to other entities such as date/time entities across one set of dimensions, may connect to entities describing uses across another set of dimensions, may connect to entities describing users across another set of dimensions, and so forth.

An additional term is ‘latent social networks’. Latent social networks constitute networks of users that share a common characteristic in which the members of this network have not explicitly created a connection nor identified themselves as a member of this group. Networks can be composed dynamically based on a specific context. Context can be defined by the user data extracted. An example is that based on a specific context a network of computer systems interacts with a network of users. The resultant interaction creates a new multi-dimensional set of relationships between the two primary networks. Latent social networks can contain friends and family, friends of friends, experts, people who share certain characteristics in context, people who have produced relevant content to the context, and brands. ‘Members’ of latent social networks are users that are determined by the system to match a specific user or context around which the latent social network is being formed. Membership is determined by the extent of match as determined by various weighting algorithms. Specific business rules or requirements can create threshold values for latent social network membership.

An additional term is ‘context’. Context describes the circumstances and conditions which a specific network that defines the entities, the entity types, the entity attributes, and the connections and the connection attributes. Examples of context include date, time, creator, view, uses, and network state.

An additional term is ‘fractal’. Fractal relationships describes mathematical characteristics of networks in which network patterns have statistical self-similarity at all resolutions and the underlying generated by an infinitely recursive process. Fractal attributes of networks comprise geometrical and topographical features are recapitulated in miniature on finer and finer scales. Topographical or topological features comprise network structures that define entity cluster across and within dimensions. Topological features include but are not limited to small world clustering, shortest path, numbers of connections, etc.

An additional term is ‘adaptation and learning’. Adaptation and learning is used to describe specific algorithms that are adopted in the present invention. Adaptation and learning describes an architectural attribute of the present invention. Adaptation and learning describes an architectural structure, process or functional property of the algorithms in which the algorithm evolves over a period of time by the process of natural selection such that it increases the expected long-term reproductive success of the algorithm. Operating in the present invention, the actual computer system operates as a complex, self-similar collection of interacting adaptive algorithms. The present system behaves/evolves according to three key principles: (1) order is emergent as opposed to predetermined, (2) the system's history is irreversible, and (3) the system's future is often unpredictable. The basic algorithmic building blocks scan their environment and develop models representing interpretive and action rules. These models are subject to change and evolution.

An additional term is ‘persona’. Persona is used to describe amalgamation of all digital information related to a specific user, and organized and processed in order to understand psychogenic attributes of the user including preferences, lifestyle, attitudes, beliefs and behaviors. Attributes could include a user's brand preferences, purchase and loyalty behavior or wants, desires or needs. Attributes could also include long and short term motivations and specific problems the user is intent on solving.

Finally, an additional term is ‘semantic graph’. A semantic graph is a term coined for the present invention and is an exemplary embodiment. It is meant to convey an ontological representation. An ontology is an explicit, formal specification of how to represent objects, concepts, and other entities and the relationships that hold among them. These specifications may or may not be hierarchically structured. As used herein, “ontology” or “ontological model” is used to describe conceptual models that describe concepts and their relationships. These models rely upon a logical framework (i.e., “formalism” or “description logic”) that describes how these concepts and their relationships can be represented. As described herein, a latent social network is an ontological model that is defined across multiple contexts and represents concepts and their relationships in terms of adaptational algorithms.

Rather than explicitly defined, a latent social network contains information about people and their relationships that have been extracted from latently defined framework which comprises concepts (e.g. “Today is Monday”), properties to be associated with concepts (e.g., “Date has month/day/year”), rules to applies to concepts (e.g., “Departure Date must be before Return Date”), and queries to be run (e.g., “Provide Travel Itinerary”). The logical framework also enables relationships to be defined among concepts, for example by using constructors for concept expressions such as “unions,” “negations,” “number restrictions,” or “inverses.” Semantics is a word that merely means “of or relating to the meaning of language.” While the term ontologies is used in the present embodiment of the invention it is used merely for illustrative purposes and should not be seen as solely as a method of ontological generation but as a term representing a body of techniques and representational models for representing knowledge, categories, logical relationships and characteristics, indices, and taxonomies and classifications.

System Overview

Turning first to FIG. 1, a computer system 100 according to an exemplary embodiment of the present invention is illustrated. The computer system comprises a sub-system for the auto-generation of network models 107 (also referred to herein as ‘network modeling system’ 107), which includes a number of components (103, 104, 106) and carries out a number of steps, as will be described in detail hereinafter. Specifically, the network modeling system 107, includes an information processing component 106, an application processing component 104, and a fractal datastore 103. The network modeling system 107 may receive digital information 105 from various sources or feeds (e.g., blog entries, Short Message Service (SMS) messages, Multimedia Message Service (MMS) messages, web site histories, etc.). Exemplary embodiments of network modeling system 107 are described in detail in previously-filed patent application U.S. Ser. No. 12/726,460, entitled “METHODS AND SYSTEMS FOR AUTO-GENERATING MODELS OF NETWORKS FOR NETWORK MANAGEMENT PURPOSES,” the entire contents of which are hereby incorporated by reference.

The information processing component 106 processes feeds from a user's online activity, personal datastores, user behavior, calls to APIs to applications used by an individual, and/or content served on webpages. These may be termed ‘artifacts’ in the exemplary embodiments of the present invention. Network models may, in turn, comprise information that describes people, their relationships, their activities, and the content they produce or consume. Relationships may comprise explicitly defined connections or interactions between entities, and latent relationships which may be established through various statistical and analytic techniques that are capable of deriving relationships between entities. Network models may include outputs defined according to the exemplary embodiments of the present invention or may comprise, for example, ontologies, taxonomies, data models, file structures, XML schemas, controlled vocabularies, Unified Modeling Language (UML), and/or other graphical or narrative descriptions of entities and their relationships.

Digital information 105 may include, for example, network models, documents, spreadsheets, software code, computer transaction logs, message logs, e-mails, instant messages, webpages, databases, directory services for users and groups of users, file systems, digital media, digital media and content repositories, enterprise resource repositories, enterprise metadata repositories, web services, web service directories, application programming interfaces, message specifications, network and system management systems, and knowledge management systems. Digital information 105 may also comprise things like blog content, microblog (e.g., Twitter®) content, Short Message Service (SMS) messages, Multimedia Message Service (MMS) messages, and user profiles.

Broadly described, digital information 105 may be processed, and associations may be created, within a specific artifact by the application processing component 104, and further associations may be created with data already in the datastore 103. The result is an n-dimensional graph in which every token (or node) is connected with ever other node. A user may create contextual information and events that result in extraction of sub-graphs from the datastore 103, and stimulation of algorithms that identify relevant dimensions and the relative distance of dimensions and nodes across dimensions. Algorithm composites are then executed against the resultant data. A user may examine the result set and (using feedback and adaptational or evolutionary algorithms) optimize the algorithm compositions for best fit. The result is an optimized algorithm and result set for the specific context. This result set can be transformed into a format that is processable by a third party computer system.

Referring again to FIG. 1, it should be understood that independently-operating or pre-programmed third party computer systems 101, 102 may also be operative to access, invoke and execute eco-systems automatically (such as at pre-programmed times), or in response to particular input stimuli that causes such independently-operating computer systems to run a program to access the network modeling system 107. Thus, although the discussion in the examples which follow is primarily in the context of the formation and output of a network model, it should be understood that the examples apply equally regardless of whether the models are accessed through a user interface on the initiation of an end-user's computer system, or an automated third party computer system.

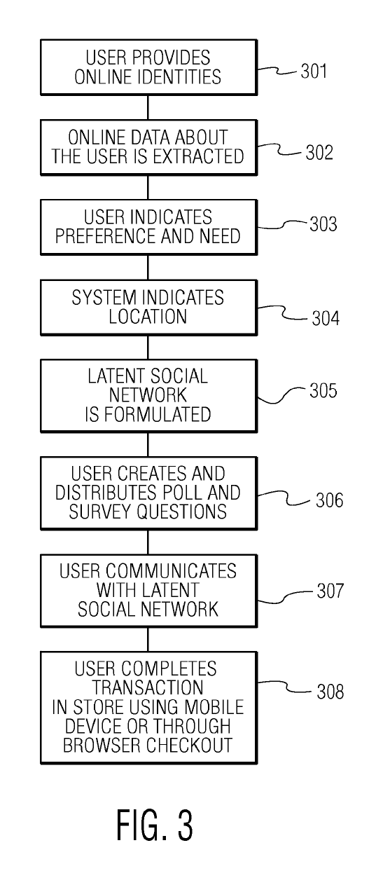

For example FIG. 1 shows example third party computer systems which comprise a desktop computer 101 and a cellular telephone 102. A user may utilize one or more of these third party computer systems 101, 102 to access the network modeling system 107, and provide artifacts thereto for processing (as described in more detail below in connection with FIG. 3). As noted above, such artifacts may be provided over a wired or wireless network, such as the Internet, or an Intranet.

The processing of digital information 105, by the information processing component 106, may occur through series of steps described in detail with reference to FIG. 2. To begin the process, a digital information processing component 201 receives digital information (e.g., through data extraction or a data feed). In the exemplary embodiment shown in FIG. 1, such digital information 105 may originate with one or more third party computer systems 101, 102, such as desktop computers and cellular telephones. Digital information 105 is processed by the digital information processing component 201 with specific context information. Context comprises any or all meta-data defined at the time of the processing of the digital information 105. Context can be defined by a user, or by the networking modeling system 107. The digital information processing component 201 parses and tokenizes digital information and disambiguates the information tokens. Hereinafter, the term ‘token’ will be used to represent the individual datum that results from the parsing and disambiguation process. It should be further understood that since these tokens are represented in the form of a token and its relationships (e.g., a graph), that the terms ‘token’ and ‘node’ are synonymous, and are used interchangeably and assumed to have equivalent meaning for purposes of the exemplary embodiments of the present invention.

The digital information processing component 201 also disambiguates the digital information 105. For those familiar with the state of the art, disambiguation is the process of determining in which sense a word having a number of distinct senses is used in a given sentence. During the disambiguation process, n-grams are created for each token. An n-gram is a sub-sequence of n tokens from a given sequence. Each n-gram may be associated with the specific context. As a final step, ‘garbage’ is written to the datastore 103 by the digital information process component 201. In the exemplary embodiment, ‘garbage’ comprises any content that has been parsed and tokenized into a form in which the structure of the information has been maintained. Specifically, this entails describing the relationships between the token and other tokens contained within the source content (e.g., the set of tokens contained in a sentence, etc.) or the relationship between a token and one or more indices.

Next, an affinity generation component 202 generates connections among the tokens. Each token is associated with every other token using n-grams as the association mechanism for the specific digital information set. Distances, computed as the number of tokens separating a pair of tokens, are computed. Additional associations are also computed as a result of explicit and latent hierarchical structural relationships and other association patterns. As a result, a recommendation component 203 generates recommendations of people associated with a user and the user's contextual characteristics, thereby forming the latent social network. The recommendation component 203 creates associations between a user, the user's characteristics and other users that form the latent social network. These associations are made based on the processing of the user attributes and the historical data that defines explicit and implicit social relationships and their behavior. The recommendation component 203 also associates a specific user with a specific marketing promotion.

Turning to FIG. 3, the flow of digital information from the third party computer systems 101, 102 to the network modeling system 107 occurs through series of steps described in detail hereafter. In Step One (301) a user provides online identities allowing the system to extract digital information about the user and the user's relationships. For example, the user may enter profile information to initiate an account on Facebook®, or edit such information in the case of an existing account. The user information may include information on affinities or associations, such as likes/dislikes and groups to which the user belongs. In Step Two (302) online data about the user is extracted. This process may be as simple as extracting name and e-mail information, or may be more complex, such as identifying interests or topics discussed and recorded within the application (e.g., writing something on a friend's Facebook® Wall). Online data can include data that is available in other applications and is accessed after the user provides permission. Online data can also include information that is available on the Internet and that is available using existing search or indexing user or application interfaces and is obtained through those interfaces. Online data can also include information that is directly solicited from the user by the system. For example, a user may register with the system providing various online usernames and be asked to stipulate the privacy controls on the information. In Step Three (303) the user indicated preference and needs are processed by the system. Preferences and needs can be relatively static and permanent or very contextual and ephemeral. An example of a contextual need may be that a user is located near a restaurant, has a meeting scheduled but no location specified and it is lunchtime. Another example, the user may be presented with a poll or survey to which they respond, or may passively indicate need by performing a search for a certain item to purchase (using, for example, an Internet search engine like Google®). In this Step Three (303) any technique for extracting need or preference may be utilized. These techniques include topic or semantic analysis of need as expressed latently within online data (e.g., a user instant messages to a friend ‘I need a new car’), may include real-time communication techniques such as instant or text messaging, or more formalized survey and polling techniques.

In Step Four (304) the system identifies the user's location. This may be accomplished using GPS technology (in the case of a cellular phone or other device equipped with such capability), or using the location of the static IP address for the laptop, desktop or other computer device being utilized (e.g., computer system 102 in FIG. 1). In Step Five (305) a latent social network is created. The information obtained in Steps Three (303) and Four (304) provide the context constituting location, persona, and specific problem or motivation. Based on the context the system analyzes all other users based on the context and determines the closest match. A latent social network may comprise a set of weights or rank ordering of users based on the extent of the match. Matching can occur using a variety of algorithms that weight various aspects of context including availability, persona attributes, and specific problems. Since each user can express these aspects in various ways the system cannot directly match across attributes. With each new capture of a user context a latent social network is re-determined. As context changes the user rankings change and therefore the weighting of users within the latent social network changes. System provided parameters can also be used to establish the degree that the latent social network changes with changes in an individual's context.

In Step Six (306) the user is able to solicit and share information with members of the latent social network using a number of techniques. These techniques including being able to view relevant user generated content that relates to the specific context associated with the latent social network. Techniques include use of formalized and structured techniques involving the creation and distribution of poll and survey questions. As information is shared occurs the user profile is extended with an increased understanding of the user. The system can reform the latent social network based on these new profile attributes. In Step Eight (208) the user communicates with the latent social network. Techniques also include the ability to communicate with the latent social network using real-time techniques of instant messaging, email, SMS, Bluetooth communication or micro-blogging. Communication can occur using system-enabled functions, or by use of third party functions that are integrated with the system. For example, a user could use Twitter® to communicate other members of the latent social network. As communication occurs the user profile is extended with an increased understanding of the user. The system can reform the latent social network based on these new profile attributes. In Step Nine (309) the system delivers a promotion that is either targeted to the user based on the interactions within the latent social network, or the system enables the sharing of promotions from latent social network members. The user may complete a purchase transaction in store or on a mobile device through a merchant independent checkout.

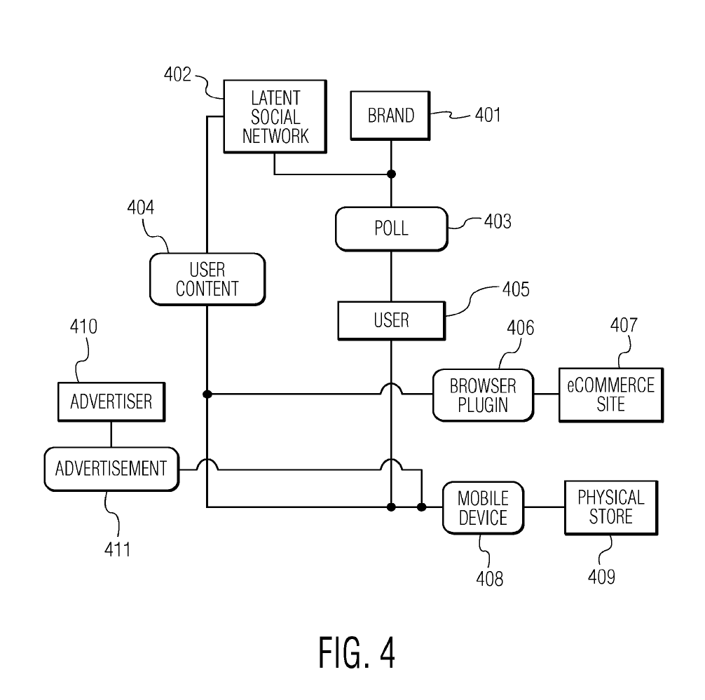

In FIG. 4 a specific exemplary embodiment of the invention is described for illustrative purposes. In particular, FIG. 4 shows a block diagram of a system for carrying out the above-described method. A user (405) accesses the system through either a web browser plug-in (406) or a mobile device (408). The web browser (e.g., Internet Explorer®) plug-in allows a user to view a commerce website (407). For example, a user has downloaded and installed the browser plug-in and is using a web browser to shop for a flat-screen television. A user searches for flat-screen televisions on www.amazon.com. As the user views a specific model television, the user is also able to view a latent social network (402) of individuals who share the characteristic of purchasing a flat screen television at www.amazon.com, or other online retailers. A user can then share content (404) with members of the network. For example, a user may share a product review. A user can also solicit information using a poll (403). The user may ask members of the network their viewing habits and the types of programs they like to watch. A brand (401) (e.g., Samsung) can participate by providing responses to the poll. An advertiser (410) may create an advertisement or promotion (411) for the brand (401) (e.g., in the case of Samsung, possibly an advertisement for a new High Definition Television with 1080 dpi, Model 1234). The advertisement (411) may be accessible by the user (405) through a browser plug-in (406) when the user is at an online ecommerce site (407) (e.g., www.amazon.com), or to a mobile device (408) when the user is in a physical store (409) (e.g., Best Buy).

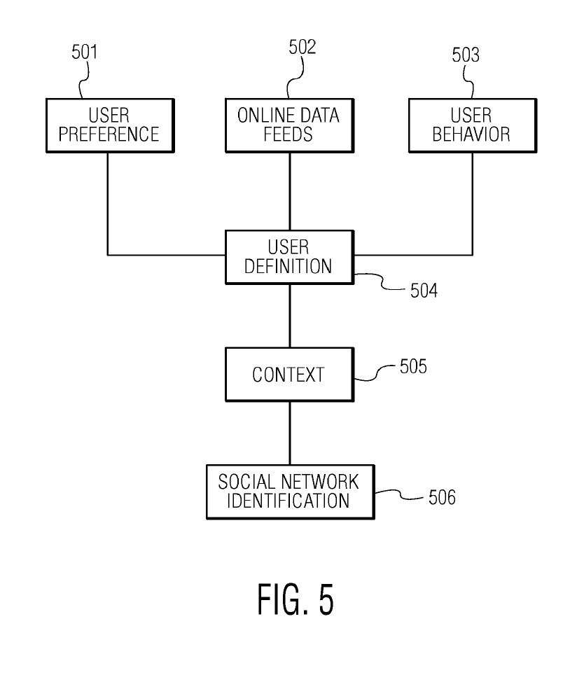

In FIG. 5 a logical data model of the user profile is illustrated which comprises a definition of a user (504) (e.g., user (405) in FIG. 4) which may include information regarding user preferences (501), online data feeds (502), and user behavior (503). This user definition is defined with a specific context (505) which when matched to other users creates a social network identifier (506). This data model indicates the types of user information that may define a user within a specific context.

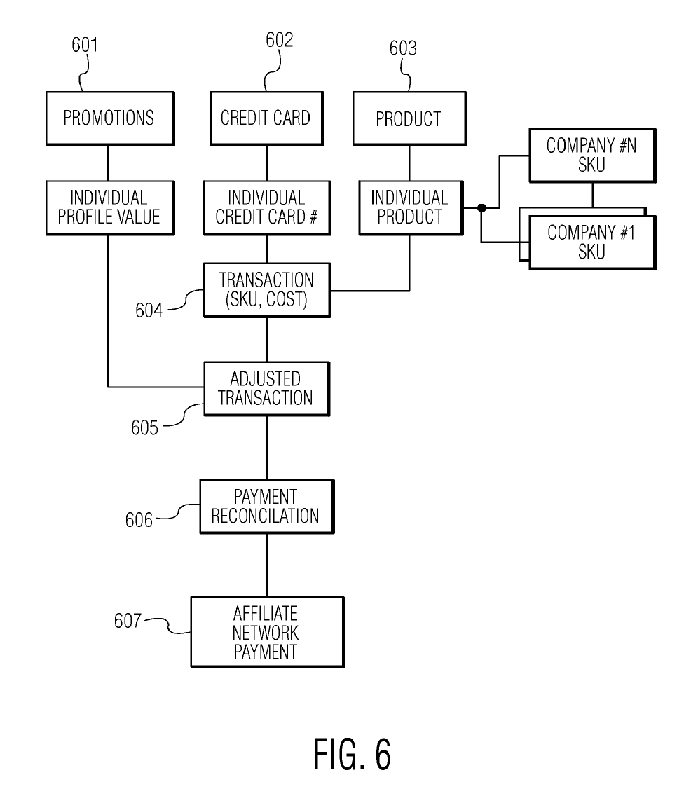

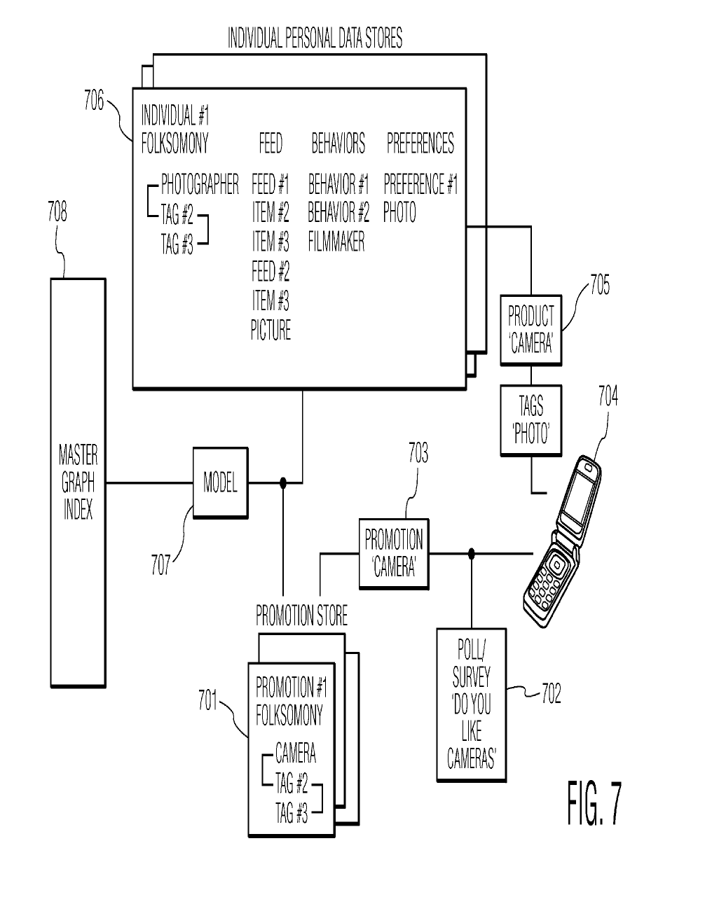

In FIG. 6 a logical data model for product and promotion information is shown (e.g., information about a product shown on ecommerce site (407) in FIG. 4), and transaction flow is modeled. In FIG. 6, a promotion (601), a credit card (602), and a product (603) are processed each containing one or more instance values. For example, a coupon for a Samsung High Definition Television has a value of $200 off the list price. A user's credit card number (602) is registered within the system. It is used to purchase the product (603) with a specific SKU or other product identification number. The cost of the purchase for the specific SKU is a specific amount (604). In this example, the amount is $1000. Through the reconciliation of promotion value with the specific transaction using financial processing networks there is an adjustment to the transaction (605). In this example the adjustment is $200 off for a sale price of $800. The system reconciles the payment by crediting the card (606). In this example, $200 is credited to the registered credit card (602). Following the reconciliation the payment to members of the latent social network who participated in the transaction are compensated (607) based on some algorithm. For example, if 8% of the value of the transaction is paid as part of an affiliate relationship with a latent social network then $64 is available for distribution. Similarly, the algorithm may consist of 8% of the promotion value which would be $16.

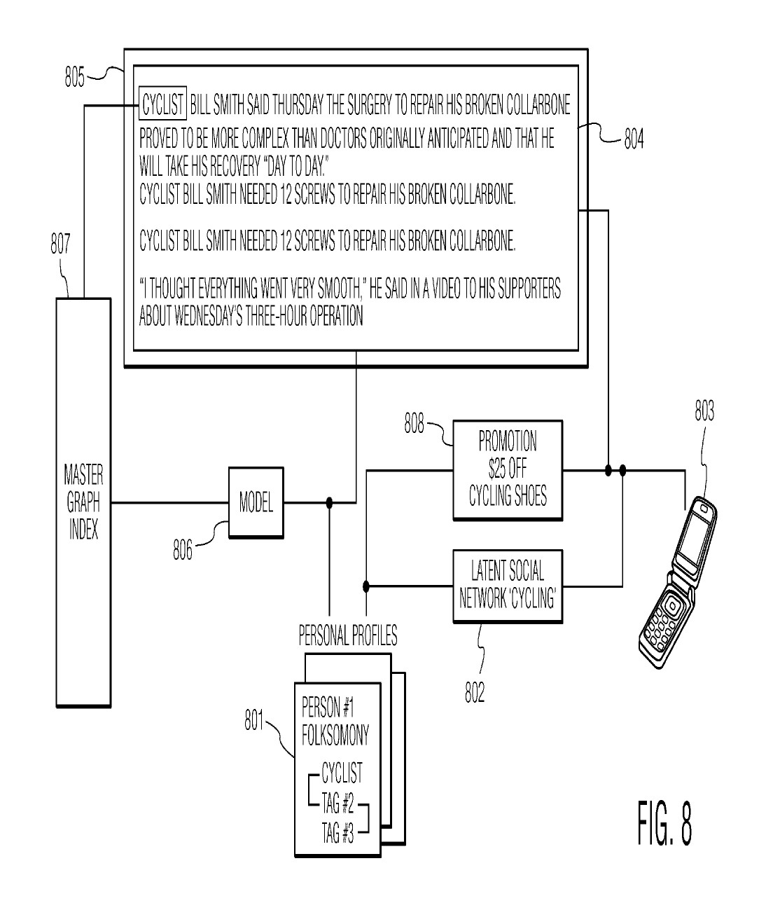

FIGS. 7, 8 and 9 comprise block diagrams illustrating how content about a product, or about a user, may be used to associate products, people and promotions together in order to establish the membership of a latent social network, and/or a relevant promotion based on the specific user's characteristics. These figures show how data is processed in the system and method according to the exemplary embodiments of the present invention, and how associations are made. Each figure illustrates a different use of the system.

FIG. 7 shows how a promotion is associated with a specific user based on their user profile. FIG. 7 shows a block diagram relating to the population of a datastore containing profile information (706), where all user data may be stored. An individual user may have a user definition (504) that may comprise personally created content in the form of poll responses and communications which can be tagged and represented in a folksomony, data feeds (502), behaviors (503), and preferences. In this specific example, multiple data points within the user definition are associated with cameras, photography and photos. The user may have a preference for a specific product (705) (in the present example, a camera) described or indexed in a specific way (706) which may be articulated on a platform such as a cell phone (704). Polls and surveys (702) may also be created to augment the understanding of the product. In the present example, a poll was created about whether a person likes cameras.

In parallel, a set of promotions (701) exist in the datastore (706) and these promotions are similarly tagged. In this example, a specific promotion is tagged as related to ‘cameras’. The system uses a master graph index (708), stored in the datastore (103) after processing by the affinity generator (202) traverses the n-dimensional graph to result in a model (707) which matches the promotion (703) to the user based on information processed from the personal datastore (706). The master graph index is used to create a model (707) that associates the specific promotion (703) to the product preference (705), poll, survey or communicated content (702) and user definition (504) as stored in the personal dataset (706) and delivered to the mobile phone (704).

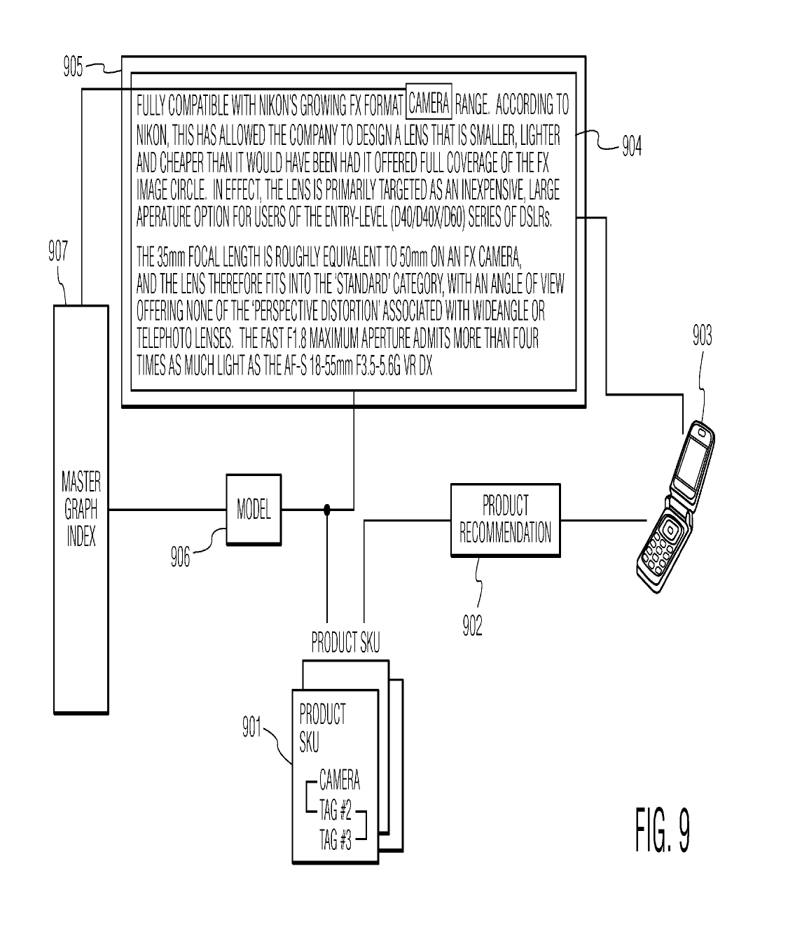

FIG. 8 illustrates how product content may be used to form a latent social network and find a promotion. In FIG. 8, an illustrative example is shown where content (804) displayed in a browser (e.g., Internet Explorer®) (805) is processed and tokens are related to a master graph index (807). In the present illustration the token ‘cyclist’ is mapped to the master graph index. A model is created of associations (807). The model associates one or more personal profiles (801) and a ‘cyclist’ tag thereby forming a latent social network (802) and a corresponding promotion (808) concerning cameras is also associated (808) and is delivered to a mobile platform (803).

In FIG. 9, an illustrative example is shown as to how content (904) displayed in a browser (905) is processed and related to product profiles (901) and a product recommendation is delivered to a mobile platform (903). Content is processed and tokens are related to a master graph index (907). A model (906) is produced that associates the content (904) tokens to a specific product (901) and a related product recommendation (902).

In view of the foregoing detailed description of exemplary embodiments of the present invention, it readily will be understood by those persons skilled in the art that the present invention is susceptible to broad utility and application. While various aspects have been described in the context of standalone application, the aspects may be useful in other contexts as well. Many embodiments and adaptations of the present invention other than those herein described, as well as many variations, modifications, and equivalent arrangements, will be apparent from or reasonably suggested by the present invention and the foregoing description thereof, without departing from the substance or scope of the present invention. Furthermore, any sequence(s) and/or temporal order of steps of various processes described and claimed herein are those considered to be the best mode contemplated for carrying out the present invention. It should also be understood that, although steps of various processes may be shown and described as being in a exemplary sequence or temporal order, the steps of any such processes are not limited to being carried out in any particular sequence or order, absent a specific indication of such to achieve a particular intended result. In most cases, the steps of such processes may be carried out in various different sequences and orders, while still falling within the scope of the present inventions. In addition, some steps may be carried out simultaneously. Accordingly, while the present invention has been described herein in detail in relation to exemplary embodiments, it is to be understood that this disclosure is only illustrative and exemplary of the present invention and is made merely for purposes of providing a full and enabling disclosure of the invention. The foregoing disclosure is not intended nor is to be construed to limit the present invention or otherwise to exclude any such other embodiments, adaptations, variations, modifications and equivalent arrangements, the present invention being limited only by the claims appended hereto and the equivalents thereof.

Although the invention has been described in terms of exemplary embodiments, it is not limited thereto. Rather, the appended claims should be construed broadly to include other variants and embodiments of the invention which may be made by those skilled in the art without departing from the scope and range of equivalents of the invention. This disclosure is intended to cover any adaptations or variations of the embodiments discussed herein.

What is claimed is:

1. A computer system comprising:
at least one server computer; and,
at least one client computer coupled to the at least one server computer through a network;
wherein the at least one server computer includes at least one program stored thereon, said at least one program being capable of performing the following steps:
extracting data from one or more social networks;
extracting data from content socially generated by one or more users;
processing the user socially generated content in digital format to identify at least one latent social network based on a specific graphical context including the steps of:
establishing one or more relationships between the user socially generated content and information stored in a first datastore;
establishing the degree to which the user socially generated content and the one or more relationships conform to at least one predetermined pattern;
identifying a latent social network based on the at least one relationship and the at least one predetermined pattern; and,
processing a first set of user data to identify at least one user need of a user within the at least one latent social network.

2. The computer system of claim 1, wherein said at least one program is capable of performing the further step of:
enabling communication between a first entity and the at least one user; and,
delivering information relating to the at least one user need to the at least one user.

3. The computer system of claim 2, wherein said at least one program is capable of performing the further step of:
providing the at least one user the ability to purchase one or more products.

4. The computer system of claim 2, wherein said step of delivering information relating to the at least one user need to the at least one user further comprises:
delivering information related to the at least one latent social network and the specific context.

5. The computer system of claim 2, wherein said step of delivering information relating to the at least one user need to the at least one user further comprises:
delivering an offer to purchase at least one product to the at least one user.

6. The computer system of claim 2, wherein said at least one program is capable of performing the further step of:
permitting the at least one user to share the delivered information with other users of the latent social network.

7. The computer system of claim 6, wherein the delivered information comprises an offer to purchase at least one product, and the system permits the user to share said offer to purchase with other users of the latent social network.

8. The computer system of claim 3, wherein the step of providing the at least one user the ability to purchase one or more products comprises providing the at least one user the ability to purchase products over a network.

9. The computer system of claim 3, wherein the step of providing the at least one user the ability to purchase one or more products comprises providing the at least one user the ability to purchase products in a store.

10. The computer system of claim 2, wherein the step of enabling communication between a first entity and the at least one user comprises taking a survey from the at least one user.

11. The computer system of claim 1, wherein said step of processing the user socially generated content to identify at least one latent social network based on a specific context further comprises:
implementing at least one algorithm to determine the at least one predetermined pattern;
measuring feedback; and,
modifying the at least one algorithm based on the measured feedback.

12. The computer system of claim 1, wherein the latent social network comprises one selected from the group consisting of: persons, policies, procedures, and computer systems.

13. The computer system of claim 1, wherein said step of processing user information in digital format comprises generating at least one token corresponding to the user information.

14. The computer system of claim 1, wherein the first set of user data comprises one selected from the group consisting of: blog content, e-mails, microblog content, SMS messages, and user profiles.

15. The computer system of claim 1, wherein the first set of user data comprises one selected from the group consisting of: user-generated content, spreadsheets, presentations, accounting reports, system descriptions, policy manuals, and transactional data.

16. The computer system of claim 2, wherein the first entity comprises an advertiser.

17. The computer system of claim 1, wherein the step of extracting data from content socially generated by one or more users comprises:
extracting data from one selected from the group consisting of: social networking sites, blogs, and SMS messages.

18. A computer system comprising:
a digital information component coupled to the network modeling component, said digital information component extracting data from content socially generated by one or more users;
a network modeling component processing the user socially generated content in digital format to identify at least one latent social network based on a specific graphical context including the steps of:
establishing one or more relationships between the user socially generated content and information stored in a first datastore;
establishing the degree to which the user socially generated content and the one or more relationships conform to at least one predetermined pattern;
identifying a latent social network based on the at least one relationship and the at least one predetermined pattern; and,
at least one third party computer system coupled to the network modeling component over a first network.

19. The computer system of claim 18, wherein the network modeling component further comprises:
an information processing component;
an application processing component; and,
the first datastore.

20. The computer system of claim 19, wherein the information processing component parses information and creates at least one token corresponding to the information.

21. The computer system of claim 19, wherein the information processing component parses information selected from the group consisting of: blog content, e-mails, microblog content, SMS messages, and user profiles.

22. The computer system of claim 20, wherein the application processing component compares the at least one token to one or more tokens stored in the first datastore.

23. The computer system of claim 22, wherein the application processing component generates an n-dimensional graph of tokens in which every token is connected with every other token.

24. A non-transitory computer readable medium having embodied therein a computer program for processing by a machine, the computer program comprising:
a first code segment for extracting data from one or more social networks;
a second code segment for extracting data from content socially generated by one or more users;
a third code segment for processing the user socially generated content in digital format to identify at least one latent social network based on a specific graphical context by performing steps including:
establishing one or more relationships between the user socially generated content and information stored in a first datastore;
establishing the degree to which the user socially generated content and the one or more relationships conform to at least one predetermined pattern;
identifying a latent social network based on the at least one relationship and the at least one predetermined pattern; and,
a fourth code segment for processing a first set of user data to identify at least one user need of a user within the at least one latent social network.

25. The non-transitory computer readable medium of claim 24, wherein the computer program further comprises:
a fifth code segment for enabling communication between a first entity and the at least one user; and,
a sixth code segment for delivering information relating to the at least one user need to the at least one user.

26. The non-transitory computer readable medium of claim 25, wherein the computer program further comprises:
a seventh code segment for providing the at least one user the ability to purchase one or more products.

27. The non-transitory computer readable medium of claim 26, wherein the seventh code segment for providing the at least one user the ability to purchase one or more products comprises code for providing the at least one user the ability to purchase products over a network.

28. The non-transitory computer readable medium of claim 26, wherein the seventh code segment for providing the at least one user the ability to purchase one or more products comprises code for providing the at least one user the ability to purchase products in a store.
